(19) United States
(12) Patent Application Publication
(10) Pub. No.: US 2022/0188781 A1
(43) Pub. Date: Jun. 16, 2022

(54) SYSTEMS AND METHODS FOR EFFICIENT ELECTRONIC TOKEN ECOSYSTEMS

(71) Applicant: Samer M. EL-BIZRI, New York, NY (US)

(72) Inventor: Samer M. EL-BIZRI, New York, NY (US)

(21) Appl. No.: 17/643,433

(22) Filed: Dec. 9, 2021

Related U.S. Application Data
(60) Provisional application No. 63/199,190, filed on Dec. 12, 2020.

(51) Int. Cl. G06Q 20/06

(52) U.S. Cl. CPC G06Q 20/0658

(57) ABSTRACT

System and methods for improving electronic currency and distributed ledger technologies to solve price and data manipulation, control vulnerabilities, off-chain dependencies and circulation problems of electronic currency is disclosed. More particularly, the present disclosure provides technical improvements to the substantiation, issuance and circulation of electronic currency including but not limited to, issuing electronic currency at the issuer's will in single blocks of varying amounts and attributes to be circulated, transferred and used for payment on a distributed ledger network. The electronic currency of an aspect of the present disclosure are a representation of financial instruments of the issuer with legally binding obligations and rights enforceable by at least one legal jurisdiction tokenized into units of electronic currency and used to make payments. Disclosed aspects of the present disclosure provide technical solutions to price discovery and stability in relation to fiat currency; privacy protection in payment and transfer transactions; a closed loop system for the on-chain settlement of the electronic currency and financial instruments, and solves security vulnerabilities for blockchain and distribute ledger technologies including data and market manipulation, 51% control attacks and dependencies of trusted players and off-chain transactions.

### CROSS-REFERENCE

This application claims the benefit of U.S. Provisional Application No. 63/199,190, filed Dec. 12, 2020, which application is incorporated herein in its entirety by reference.

### BACKGROUND

### Field

The present disclosure relates generally to electronic tokens. More specifically, the disclosure relates to electronic transactions and distributed ledger technology, more particularly, to systems and methods for solving vulnerabilities in the issuance and circulation of electronic currency, electronic invoices, electronic payments, and associated blockchain technologies.

### Background

Satoshi Nakamoto developed Bitcoins with a stated goal of ridding the world from its dependency on central control and vulnerability to financial institutions. This noble idea was backed by a new innovation, blockchains, that made it possible to solve the double spend problem without the need for a trusted third-party to monitor and settle transactions. Price discovery from demand and supply speculation and the risk adjusted cost of using Bitcoin to pay for goods and services versus other fiat currencies, are two measures that can be used to estimate an implied economic value and conversion rate of Bitcoins comparison to fiat currencies. The first problem is the risk of price manipulation in cryptocurrency systems. Bitcoins and other cryptocurrencies have suffered from the lack of commercial circulation in the general economy because of many vulnerabilities, including price manipulation and volatility which inhibit fungibility; opaque basis for valuation in fiat currency terms due to dependency on pure consensus and the ease of creating new currency and forking with control risk and risks of data manipulation among others.

Altcoins are vulnerable to trusted third parties who may have ulterior uses for the cryptocurrency beyond its long-term stability and growth. Altcoins create additional data and price manipulation risks including pump and dump price manipulation to high-risk black-market trades or subsidized excessive mining. On the other hand, Bitcoin is still superior in utility to other altcoins, including Ethereum and EOS may add more vulnerabilities through pre-mining, merge mining and conflicted central control of various structures including EOS elected nodes, and Proof of Stake. Another problem is the attempts at substantiating an implied economic value of cryptocurrency, including stablecoin to manage price volatility. Asset-backed, algorithmic pegging and specific utility Altcoins which are intended to provide some substantiated implied value to the units of Cryptocurrency presented a new set of challenges and risks.

In most cases these stablecoin methods have eliminated more of the benefits of a closed loop ecosystem as Altcoins add off-chain risks of price and data manipulation, fraud and costs including the continued monitoring, validation and, in cases, securing and maintaining physical assets. It also presents players that can gain from gaming the system without ramifications and without long-term sustainability, for example, monitoring a supply of gold forever or algorithmically changing supply of coins without affecting circulation, in this case, coins that are not in circulation are likely to have no effect on pegging the value of circulating coins to a fiat currency, there is no economic cost to supply and parity. It can be reasonably argued that this form of Altcoins eliminates most of the benefits of blockchain protection against manipulation and bad actors.

The need for a substantive value includes adding value to the economy beyond the ease of transacting. A fundamental increase in economic benefits of cryptocurrency should increase the acceptance and use of such currency across the economy.

Another problem is cryptocurrency circulation in the general economy. Bitcoin's utility today is limited to a speculative commodity or edge case transactions, which feed its price volatility and further increases its transaction costs in everyday commerce. This puts Bitcoin at a significant disadvantage to even a few of the least circulated fiat currencies.

Unlike Bitcoins and most altcoins, fiat currencies derive their circulation and implied value from government policy, interest rate parity, estimated purchasing power parity, sovereign debt and employment levels, hard currency reserves and other factors. Less known fiat currency circulation is mainly supported by government regulation, currency controls, hard currency reserves and enforceability to use within an economy.

As an example, a construct of the implied exchange rate of Bitcoin can be an estimate of risk adjusted purchasing power parity with fiat currencies. Bitcoins price volatility and value uncertainty are a higher risk that the holder of Bitcoins takes when pricing or exchanging Bitcoins to hard currency. This risk premium cost is higher than any efficiency that Bitcoins provides over fiat currency with few exceptions, such as Bitcoins being less traceable by law enforcement and presents a lower risk premium cost to a criminal enterprise.

A variety of potential opportunities for cryptocurrency beyond transaction efficiency in solving other economic problems exist. A set of problems that cryptocurrency can address is the sufficient and efficient availability of credit and capital in economies. Credit is a fundamental element of an economy. The buying power within any economy consists of credit and cash. Credit is a transaction between a lender and a borrower, in which the borrower promises to pay back the money in the future along with interest.

Efficient access to credit enhances the ability for an individual or entity to purchase more goods and services, which in turn increases a business' productivity and an individual's standard of living. Accordingly, spending on credit generates revenues for sellers in the same economy, which generates employee incomes and overall economic growth. For a multitude of reasons most businesses and individuals globally lack access to efficiency credit. Even in the most established economies in the world, such as the United States, a very small percentage of business (an estimated 5%) hold 95% of all equity and debt capital available to businesses, while the remain majority (an estimated 95%) of business hold the remaining 5%, although represent 45% of business receipts, half of the business economy.

The credit access gap contributes to unemployment, low incomes, low standard of living in areas and geographies where the largest businesses don't operate or control the full economies of small towns and keep wages to a minimum. Cryptocurrency and distributed ledger technologies can be improved to not only simplify or reduce the costs associated with credit availability, but to fundamentally change the source and enhance the utility of credit in economies. As we will demonstrate in the present disclosure, a new system and methods for creating and distributing credit in an economy.

It is noted that even the money market for the largest corporations, which is considered the most efficient form of credit available today, can be improved and many of its major dependencies, cost and risk components removed. The rest of the world, including the European Union and Japan, have even bigger gaps and limitation to credit availability. Not surprisingly, developing economies also have large and untapped economic potential that has the potential to fuel global growth. The sheer scale and capabilities of a potentially vibrant and productive workforce, the advent of new technologies that can leapfrog costly infrastructure, and an expanding education could be great catalysts for prosperity.

Unfortunately, developing countries are hindered by numerous problems that lead to growth paralyses, including, large and expensive foreign debts, political instability, unreliable judicial systems, limited enforceability of rules and regulations, marked corruption and adverse selection from lack of transparency all contribute to stagnation, regression and lack of a healthy credit market.

What is needed are systems and methods for addressing inefficiencies of credit markets; price and data manipulations and safety of cryptocurrencies. What is also needed are credit and cryptocurrency distribution and circulation systems and methods.

### SUMMARY

Systems and methods are disclosed for improving electronic currency and distributed ledger technologies to address price and data manipulation, control vulnerabilities, off-chain dependencies and circulation problems of electronic currency. More particularly, the present disclosure provides technical improvements to the substantiation, issuance and circulation of electronic currency including but not limited to, issuing electronic currency at the issuer's will in single blocks of varying amounts and attributes to be circulated, transferred and used for payment on a distributed ledger network.

An aspect of the present disclosure, provides electronic currencies which are representations of financial instruments of the issuer with legally binding obligations and rights enforceable by at least one legal jurisdiction that are tokenized into units of electronic currency and usable to make payments.

Disclosed aspects of the present disclosure provide technical solutions to price discovery and stability in relation to fiat currency; privacy protection in payment and transfer transactions; a closed loop system for the on-chain settlement of the electronic currency and financial instruments, and solves security vulnerabilities for blockchain and distribute ledger technologies including data and market manipulation, 51% control attacks and dependencies of trusted players and off-chain transactions.

An aspect of the present disclosure, provides systems and methods for improving electronic currency and distributed ledger technologies to solve price and data manipulation, control vulnerabilities, off-chain dependencies and circulation problems of electronic currency.

Another aspect of the present disclosure provides methods for issuing, managing and circulating electronic currency on distributed ledgers and tokenizing financial instruments (where tokenized financial instruments can be referred to as token), wherein the token are used as electronic currency to make payments. Examples of such financial instruments include, but are not limited to, commercial paper, promissory notes, bonds, equity, repurchase agreements among others. These token are configurable to account for rights and obligations potentially enforceable by at least on legal jurisdiction.

Still another aspect of the present disclosure provides tokenized financial instruments forming a basis for substantiating an implied value of the electronic currency which solves vulnerabilities in electronic currency price stability and in stablecoin implementations, including, but not limited to, price volatility of exchange rates between the units of electronic currency and related fiat currencies; and (2) the off-chain risk and data manipulation associated with stablecoin dependencies on tangible asset or supply based algorithms pegging to a fiat currency.

Yet another aspect of the present disclosure provides issuers of tokens the ability to create tokens at-will in a single block on the blockchain network. Unlike pre-mining, mining and gas methods used in blockchain and distributed ledger implementations in creating token, issuers using an aspect of the present disclosure can issue token in variable amounts and units and at different times, referred to here as on-demand minting. This on-demand minting method provides a technical solution, along with other features and functions in aspects of the present disclosure, which solves vulnerabilities associated with control, price and data manipulation of cryptocurrency through pre-mining, controlling mining nodes and 51% attacks.

Another aspect of the present disclosure provides systems and methods where token are used as units of electronic currency to make payments within a closed loop ecosystem which solves for vulnerabilities of cryptocurrency and currency exchanges, including the risk of maintaining off-chain assets or performing off-chain transactions.

Still another aspect of the present disclosure provides an automated price discovery module configurable to facilitate pricing of payment transactions between a payer and a payee to enhance price fairness and ease, where prices incorporate opportunity cost estimates through auction price discovery. This price discovery module and method contributes to greater price transparency, to enhanced utility over fiat currency transactions, and to improved circulation of the electronic currency in everyday commerce.

Yet another aspect of the present disclosure provides systems and methods where an issuer embeds the legal obligations of a financial instrument in an electronic currency token to use for payments. This tokenization method and supporting system and methods of creating, managing and settling these token obligations on-chain provide a large savings and resource opportunity for issuers and economies in general. Whereas, an issuer using the present disclosure reduces its dependency on fiat currency funded sales of financial instruments to investors and eliminates several steps, costs and vulnerabilities, including but not limited to, (1) securing investments from investors; (2) liquidity risk and availability of capital to fund financial instrument sales; (3) eliminate the need for intermediaries such as money market dealers, administrators and banks; (4) eliminate the risk of holding fiat currency in bank accounts; (5) eliminate steps in selling financial instruments to investors first to then funding payments from the proceeds of such investments; (6) eliminate uneven cash flow cost and risk between fixed commitments to investors and variable needs of the issuer, including size and frequency of transactions; (7) eliminate costs associated with structuring conduits, administrating and servicing the financial instrument lifecycle; (8) reduce the cost and need for credit, trade finance, wire transfers, international payments, currency spreads and more; (9) reduce the similar costs and needs of number 8 for trade partners and suppliers; and more.

Another aspect of the present disclosure provides systems and methods where tokens are created, managed, transferred and settled on a closed loop ecosystem on a blockchain network, using executable code that is executable by one or more computing device processors based on the disclosed features, functions and methods herein. The closed loop ecosystem enables the blockchain network to use proof of work and maintain high transaction speed and scalability because of updating the distributed ledger when token are taken forever out of circulation or destroyed.

Yet another aspect of the present disclosure provides computer based systems for issuing and circulating electronic currency is disclosed, the system comprising: a distributed blockchain network and virtual machine, self-regulating and self-adjusting smart contracts to create, manage and configure token and transactions of cryptocurrency, user accounts consisting of data storage units with messaging capabilities to hold cryptocurrency and communicate with other accounts, price discovery and closed loop settlement.

Still another aspect of the present disclosure provides systems and methods where token of different issuers and attributes, for example, token representing different financial instruments, can be created, exchanged, transferred and settled between accounts on the same blockchain network.

Another aspect of the present disclosure provides systems and methods where token are issued in denomination equivalent to those of related fiat currencies, e.g. a token backed by an obligation valued in Yen should be equal to 1 Yen per 1 token. This further simplifies the circulation and valuation of the electronic currency on the blockchain network.

Still another aspect of the present disclosure provides technical solutions to price volatility and manipulation in cryptocurrencies without reliance on off-chain tangible assets such as deposits of cash, gold or other assets that create off-chain risks of fraud and of complex ongoing security with substantial vulnerabilities.

Yet another aspect of the present disclosure provides systems and methods configurable for tokenizing financial instruments and credit in a closed loop ecosystem.

Another aspect of the present disclosure provides that token are issued and backed by the full faith and credit of the issuers, whether as debt or any representation and warranties made by the issuer, whereas such backing is a legally enforceable agreement in at least one jurisdiction and such representation and legal agreement and jurisdiction information is made publicly available to the network. This helps substantiate the value of the cryptocurrency in fiat currency terms and provides protection of off-chain rights that are enforceable without the need for physical assets and algorithmic pegging in stablecoin and therefore ridding the system of any risks and vulnerabilities that those methods add to cryptocurrency.

Still another aspect of the present disclosure provides systems and methods where issuers of electronic currency or cryptocurrency are high credit worthy legal entities, e.g. AA or P-1 rated or credit enhanced or backed by a high credit worthy legal entity. The high credit worthy entities are referred to as Tier-1 credit entities. These Tier-1 entities are rated by well-known credit rating agencies and validated by other users on the network.

Another example of an aspect of the present disclosure for lending without fiat currency funding.

Still another aspect of the present disclosure provides systems and methods wherein issuers with lower tiered credit worthy issuers can purchase insurance on-chain by exchanging their token with those of an Insurer or credit enhancer's token. For example, an individual or a small business can issue token and exchanges such token with token issued by one or more Tier-1 rated entity, insurance company or lender (“Tier-1 lender”), whereas the Tier-1 lender holds the issuer's token in its on-chain account and assumes the credit risk on the issuer's token and the issuer's ability to meet its obligation based on certain terms and conditions embedded in a smart contract with executable code on the blockchain network. This aspect of the present disclosure provides greater ease of fungibility and circulation of the electronic currency and opens new opportunities and resources throughout the economy, whereas Tier-1 lenders can lend their credit rather than fund loans with fiat currency and borrowers can access new loans and lenders with less capital restrictions.

Both the foregoing general description and the following detailed description are exemplary and explanatory only and are not restrictive of the disclosed aspects, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

U.S. Pat. No. 11,188,897 issued Nov. 30, 2021, to Kurian;

U.S. Pat. No. 11,171,781 issued Nov. 9, 2021, to Khan, et al.;

U.S. Pat. No. 11,164,254 issued Nov. 2, 2021, to Gordon III, et al.;

U.S. Pat. No. 11,159,306 issued Oct. 26, 2021, to Ow, et al.; and

U.S. Pat. No. 11,094,014 issued Aug. 17, 2021, to Gordon III, et al.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative aspects, in which the principles of the invention are utilized, and the accompanying drawings of which:

FIG. 1 illustrates blockchain and virtual machine network components, according to one aspect of the present disclosure;

FIG. 2 illustrates a validation and guarantee process to enable a user to issue token 110, according to one aspect of the present disclosure;

FIG. 3 illustrates minting of token method, according to one aspect of the present disclosure;

FIG. 4 illustrates the transfer of token from one account to another using the blockchain network, according to one aspect of the present disclosure;

FIG. 5 illustrates an example of the use of price discovery through an automated auction mechanism, according to one aspect of the present disclosure;

FIG. 6 illustrates an example of a token's life cycle, according to one aspect of the present disclosure, starting from issuance to settlement and termination of token;

FIG. 7 illustrates the use of a program that facilitates the matching and settlement of token on the network without off-chain dependencies, according to one aspect of the present disclosure; and

FIG. 8 illustrates an example of the randomized transfer function of an aspect of the present disclosure.

### DETAILED DESCRIPTION

Various aspects and aspects of the inventions will be described with reference to details discussed below, and the accompanying drawings will illustrate the various aspects. The following description and drawings are illustrative of the invention and are not to be construed as limiting the invention. Numerous specific details are described to provide a thorough understanding of various aspects of the present invention. However, in certain instances, well-known or conventional details are not described in order to provide a concise discussion of aspects of the present inventions.

A computer-based system for issuing and managing two or more electronic tokens in a computing system network is provided. In the computer based system each of the two or more electronic tokens have one or more attributes and the computer based system comprises: at least one executable code module executable by at least one computing device processor configured to create and manage the two or more electronic tokens wherein each of the two or more electronic tokens have an issuer; a user-interface configurable to allow a user to trigger the at least one executable code module to create a block in a blockchain on user demand wherein the block has at least one new electronic token, wherein the at least one executable code module is configurable to manage a transfer of two or more electronic tokens within a blockchain, further wherein the two or more electronic tokens have at least one of different electronic token attributes and different electronic token issuers.

A computer-based system for validating data on one or more distributed ledgers is also provided. The validating computer based system comprises: at least one executable code module executable by at least one computing device processor and configured to validate data on a computing system network, a user-interface configured to allow a user access to validate data related to electronic tokens by use of a private key to cryptographically sign the electronic token, wherein the user can have one or more accounts with one or more addresses.

A computer-based system for price discovery on a distributed ledger in a blockchain network with user accessible accounts is also provided. The Price discovery computer based system comprises: at least one executable code module, executable by at least one computing device processor, and configured to provide price discovery and matching of exchange prices of electronic tokens on the same blockchain network having the same user accessible accounts; and a user-interface allowing a user to use a private key access to validate data related to electronic tokens by cryptographically signing the data.

A computer-based system for randomizing electronic currency transfers between at least two users on a connected network is also provided. The randomizing system comprises: at least one executable code module, executable by at least one computing device processor, and configured to provide a splitting of electronic currency units being transferred from at least one user to at least another user, among multiple accounts of each user; and a user-interface allowing a user to use a private key access to enable a user to trigger transfers using the executable code.

A computer-based system for transforming legally binding financial instruments into cryptocurrency is provided. The instrument conversion system comprises: a non-transitory computing network with at least one processor executing computing code; at least one programming module executable by at least one processor for creating electronic currency and storing data; at least one user with an interface for triggering a creation and management of self-regulated executable code contracts for the creation and management of electronic currency; at least one account of data storage on at least one computing device to store the electronic currency and related data; triggering a transfer of electronic currency from one account to another; and at least one programming module executable by at least one processor for locking the electronic currency in an account and disabling its circulation among accounts.

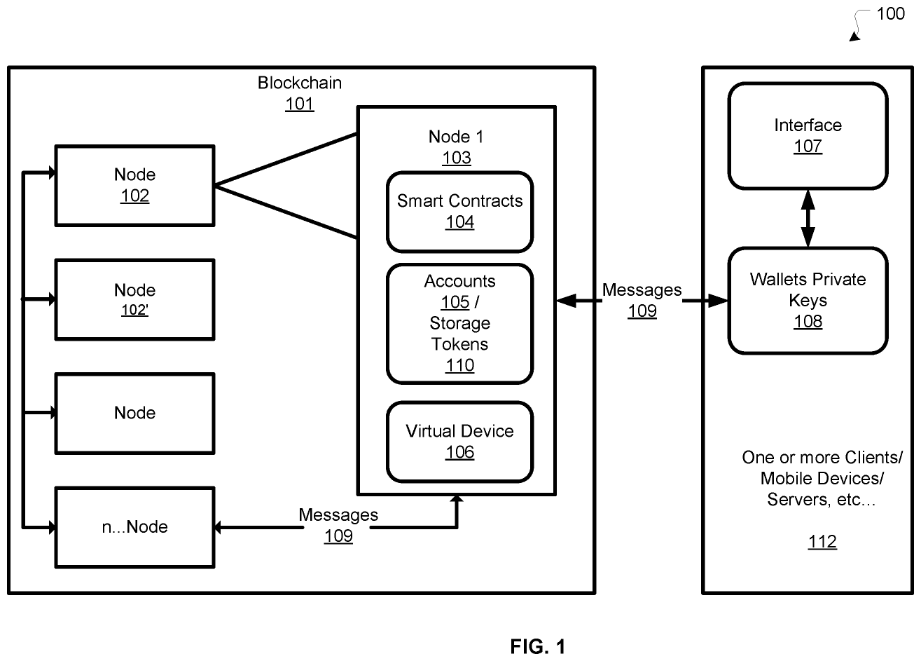

FIG. 1 illustrates a blockchain network 100 with a blockchain 101 and its components in communication with one or more client mobile devices 112 and/or servers. The blockchain 101 provides agent program. The agent programs are executable code, such as the system smart contract 104, discussed below that facilitate, enforce and support a standard or standards on the network. The system smart contract 104 can be any of a variety of smart contracts or smart contract modules, including but not limited to a payment auction smart contract, a bidder payment contract, a mining smart contract, a minting smart contract, an escrow smart contract, and a purchase and/or sale smart contract, as discussed in the figures and examples below.

The blockchain 101 includes a distributed database that is updated by one or more computing devices through a computing interface (including a graphical user interface) and shared across a network of a plurality of computing systems, or nodes 102, 102′. The blockchain 101 is configurable to support the execution of the system, functions, methods and data management disclosed herein. The blockchain 101 can also use a public blockchain and a private blockchain. Additionally, in at least some configurations, Hyperledger is used and configured to execute the functions and abide by defined standards. The blockchain 101 can also benefit from improvements and difference in minting and management of the token 110, accounts 105 and system smart contract 104.

The system smart contract 104 can be self-regulating digital contract with functions, instructions, stored data. The system smart contract 104 are configurable to be deployed and run on the blockchain's 101 virtual computing device 106 and can be automatically assigned a new account by the blockchain 101, to receive and send messages 109, data and token 110. Additionally, an issuer can use an interface to write a system smart contract 104 following an accepted standard for the purpose of the system smart contract 104; and then deploy the system smart contract 104 to the blockchain 101. When an issuer uses an interface to write a system smart contract 104 based on accepted system smart contract 104 standard and uploads the system smart contract 104 to the blockchain 101, the system is configurable to test the system smart contract 104 against the system smart contract 104 standard. Once the system smart contract 104, is tested the system will accept the system smart contract 104 or reject the system smart contract 104. When the system smart contract 104 is accepted the system will deploy the system smart contract 104 and give the system smart contract 104 an account 105 address.

Each node 102 is configurable so that an individual node, such as node 1 103 has a plurality of components including, but not limited to, system smart contract 104, accounts 105, storage token 110, and virtual devices 106.

The virtual computing device 106 is configurable for use in a network computing environment of at least two connected computing devices. Moreover, the virtual computing device 106 utilizes the computing power of the computing devices connected to the blockchain 101 to execute code on the blockchain 101, including programmed modules such as system smart contract 104, accounts 105, storage token 110 and block creations, among others. The networked computing environment supports each individual node, such as node 1 103, communicating messages 109 within the network of nodes 102.

The account 105 is a digital storage with executable code, executable on at least one computing device. The account 105 maintains a ledger of the digital token 110 stored on a distributed ledger on the blockchain 101 and where token 110 are received, sent and held. The ledger reflects a balance for the digital token 110. The account 105 is configurable to be controlled by a system smart contract 104. A user can generate a new account 105, or a new account 105 and a private encryption key through the virtual computing device 106. The user can also use the interface to access a wallet with a private encryption key to access the user's account 105 on the blockchain 101. Accounts 105 can also be assigned addresses to send and receive message 109s.

The electronic wallet can have private encryption keys to control access to an account 105. Once accessed, the wallet can provide balances, information on data and sending transactions, among other functions.

As will be appreciated by those skilled in the art, an individual can use any suitable interface 107 to access the blockchain 101, including a web-based or computing device-based application to write and/or read executable code, instruction and/or data, including but not limited to, messages 109 to accounts 105 and the deployment of system smart contracts 104. An application programming interface (API) is developed using executable code to connect an off-chain computer program, computing device or system or a network of systems capable of running executable code to write and/or read executable code, instruction and/or data to and from system smart contract 104 or connect use one or more wallets 108 on the blockchain 101.

A message 109 is configurable to contains data and instructions to trigger executable code. Additionally, one or more messages 109 can be sent to or received through a message address for one or more accounts 105. In some configurations, all messages 109 can be configured to require a response within a specified time period, or a default time period. The time period for response is controllable by the standard that is being used. Message 109 can then be cancelled along with all its response triggers once the time provided by the standard expires.

The tokens 110 are digital data that can include a type of cryptocurrency that represent units of an asset, debt obligation, or currency and reside in accounts 105 on the blockchain 101. A token 110 can represent the value of one unit of a circulating fiat currency, e.g. 1 token 110 represents $1 of value at the time of the tokens 110 expiration date (and time) regardless of the issuer of the token 110, automatic minting rates or other data and instructions in the system smart contract 104. The token 110 can also represent units of amounts of a legally binding payment obligation of an issuer, a financial instrument of an issuer with legally binding obligations and rights enforceable by at least one legal jurisdiction, and/or units of electronic currency used to make payments.

Token standards are rules and data requirements for system smart contracts 104, accounts 105, tokens 110, messages 109 and the circulation and settlement of tokens 110 on the blockchain 101. Tokens 110 of varying attributes and from various issuers can be exchanged, transferred, and used as payment on the same blockchain network. An agent running on the virtual computing device 106 is configurable to tests system smart contract 104 builds and instructions in meeting an accepted standard or the system smart contract 104 cannot be deployed on the blockchain 101. Additionally, the designated accounts 105 on the blockchain 101 also stores the standard libraries used to validate, for example, the system smart contracts 104. Token protocols can also be provided. Token protocols are standards adopted by smaller groups of users, e.g. such as lenders having the ability to charge fees or have collateral accounts 105 in which borrowers have to maintain balances of token 110.

Any individual or legal entity can issue one or more tokens 110. Allowing any individual or legal entity to issue tokens 110, prevents a control structure by a few dominant players as to the circulation of token 110 or a bias in the participation of individuals and legal entities in the system. Thus, a user can deploy a system smart contract 104 to the blockchain 101 to mint new token 110 and trigger a signature validations function or process associated with the system smart contracts 104 executable code. In some configurations, the triggered validation signature function must complete its instructed task prior to the system smart contract 104 minting the token 110 related to the system smart contract 104. The signature validations function can be triggered upon the deployment of the system smart contract 104 once the system smart contract 104 sends a message 109 to accounts 105 of listed validators requesting signatures of the validators to approve the issuance of a set number of token 110. The validator may be an individual or entity that agreed to validate the identity of the issuer or guarantee an aspect or aspects of the token 110, e.g. vouch for or insure the identity of the issuer, guarantee payment on behalf of the issuer if the issuer defaults, represent and guarantee the accuracy of the data and the total obligations of the issuer, etc. The validator can use an interface 302 and wallet 302′ to read and reply to the validation signature request by cryptographically signing or providing the “Reject Sign” or “Accept Sign” message 109 reply to the account 105 of the system smart contract 104 that initiated the pre-mining signatures message 109.

The system smart contract 104 is also configurable to mint new tokens 110 only after securing an “accept sign” from at least one validator. For example, a Type-A Standard may require a minimum number of validators accept sign the signature validations in order for the system smart contract 104 to mint any token 110.

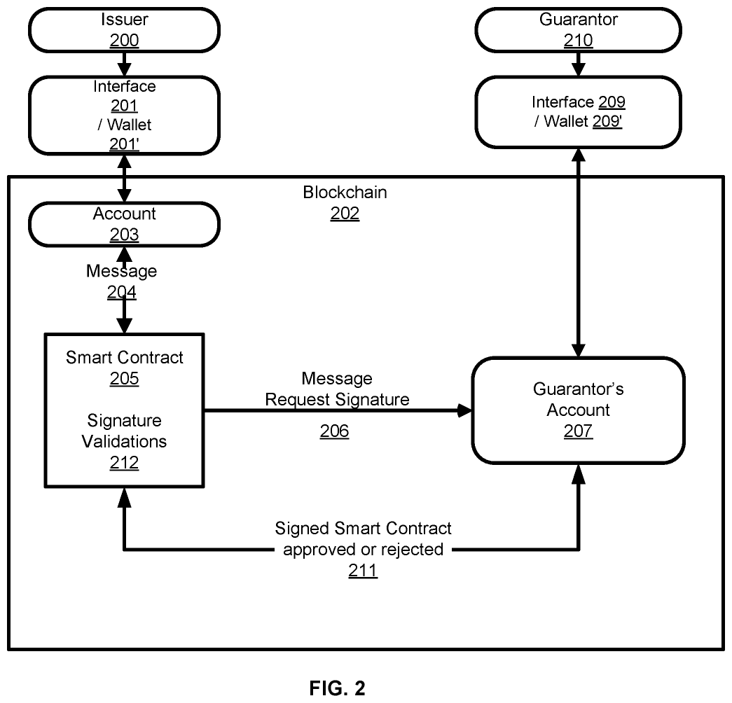

Turning now to FIG. 2, an example of an issuer 200 and guarantor 210 exchange is provided. The guarantor 210 acts as a validator in the blockchain network to validate transactions as discussed below. In this example, an issuer 200 wants to issue one or more tokens 110 backed by the issuer's full faith and credit, e.g. commercial paper units, and makes representations, warranties and guarantees to that effect in the data and instructions of the minting smart contract 205 from account 203. The issuer 200 uses the interface 201 and the private encryption key in its wallet 201′ to access the user's account 203 and send a message 204 to the smart contract 205, which in turn triggers the signature validations 212 functions in the smart contract 205. The smart contract 205 processes input from the issuer's message 204 and validates the input through the signature validations functions with other predetermined users on the blockchain 101, called validators. The smart contract 205 sends a signature request message 206 to the guarantor account 207 at the same time or sequentially through a preset hierarchy. The signature request message 206 sent by the smart contract 205 contains the data and instructions for the new token 110 and a request for the guarantor 210 to confirm data, instructions and the guarantor's role and guarantees as the smart contract 205 instructions require based on, for example, the TYPE-A Standard. A guarantor 210 can “Reject Sign” or “Accept Sign” the signature validations of the smart contract 205 and send a reply approved or rejected message 211 to the smart contract 205 with the guarantor's answer and signature. Moreover, the guarantor 210 can view the smart contract 205 and signature request message 206 and reply with an answer through approved or rejected message 211 by using an interface 209 and a corresponding wallet 209′ private key, to access the guarantor's account 207. The smart contract 205 can be configured to expire and prevent any minting of token 110 if a set number of guarantor's 210 or one or more hierarchically selected guarantor 210 does not reply by a predetermined deadline or replies with a “Reject Sign”. Additionally, a guarantor 210 can accept, accept conditionally or reject providing a guarantee related to the token 110, in part or in whole, and may comment in the smart contract 205. The issuer 200 may set the signature validations to require at least one, a majority, unanimous or any number of guarantors and set a flat or hierarchical levels of importance among them. All of the token 110 issuers and guarantors 210, including their names, their total outstanding issuance or guarantees and other related data at a publicly accessible account on the blockchain network. This account is configurable to contain a ledger and its address on the blockchain 101 and will be available to all users of the blockchain network. A system smart contract 104 is configurable to use all token 110 issuance and activities from blockchain 101 ledgers to maintain and update the account autonomously. The account and its ledger are intended to enhance confidence in the token 110 and the system and minimize adverse selection.

Any individual or legal entity can issue one or more tokens 110. As noted above, allowing any individual or legal entity to issue one or more tokens 110 prevents a control structure by a few dominant players as to the circulation of token 110 or bias the participation of individuals and legal entities. The issuer writes data and instructions to invoke the signature validation function to create a predetermined number of tokens 110 with attributes and guarantees from one or more guarantors 210. The guarantees are a guarantor minting limit. An issuer can be limited in the value and number of tokens 110 that the issuer can issue in total circulation on the blockchain network, which is an issuer minting limit. Issuer minting limits are configurable to be automatically determine by an algorithm that takes acceptance of token 110 for the given issuer and the standard deviation of their automatic minting rates and transfer acceptance rates of the given issuer token 110 in circulation on the blockchain network. An executable code module, executable by at least one computing processor, is also configurable to track the total units and attributes of all tokens 110 issued by an issuer to provide an issuer tracking module. Additionally, the issuer tracking module can also be a system smart contract 104 that saves the tracked data in at least one account. The smart contract token data in the account is accessible through messages 109 to any other account on the blockchain network. Additionally, minting limits can account for all future auto-minting of outstanding tokens 110 and all the minted and outstanding tokens 110. Minting can be on demand.

Tokens 110 are configurable to bear a unique name, which includes a ticker symbol. For example, Acme Foods Co. may have the ticker ACX2T.CP and the fiat currency to which the token 110 value is pegged as a promissory note payable by the issuer, such as AXC2T.CPUSD for U.S. Dollars.

In at least some configurations, an issuer 200 can mint token 110 at-will. Additionally, an issuer can mint token 110 at-will when the total of all outstanding tokens 110 issued by the issuer 200 are within and do not exceed a minting limit for the issuer 200 or the guarantor's 210 minting limit. An issuer 200 can also mint tokens 110 at-will in variable amounts and numbers, at different times and/or with different attributes. Each time a new token 110 is minted or destroyed all accounts 105 are updated to provide a current number of total tokens 110 issued by the issuer 200 that are in circulation in the blockchain network. An issuer 200 can also mint tokens 110 at-will by creating a new token 110 each time in a single block on the blockchain network. An issuer's 200 token 110 of different attributes are trackable and tallied with an update of all tokens 110 in the distributed ledger accessible. All issued, outstanding, expired and settled tokens 110 are trackable by an agent and available through the agent's account for all users to access on the blockchain network. An issuer can also mint tokens 110 at varying numbers and instances up to the approved guarantor minting limit or the minting limit whichever is smaller.

System smart contracts 104 may be configurable to automatically mint token 110 at a predetermined variable or fixed rate in an auto-minting process, e.g. automatically issuing and creating new token 110 at a rate of a fraction of a token 110 per unit of time.

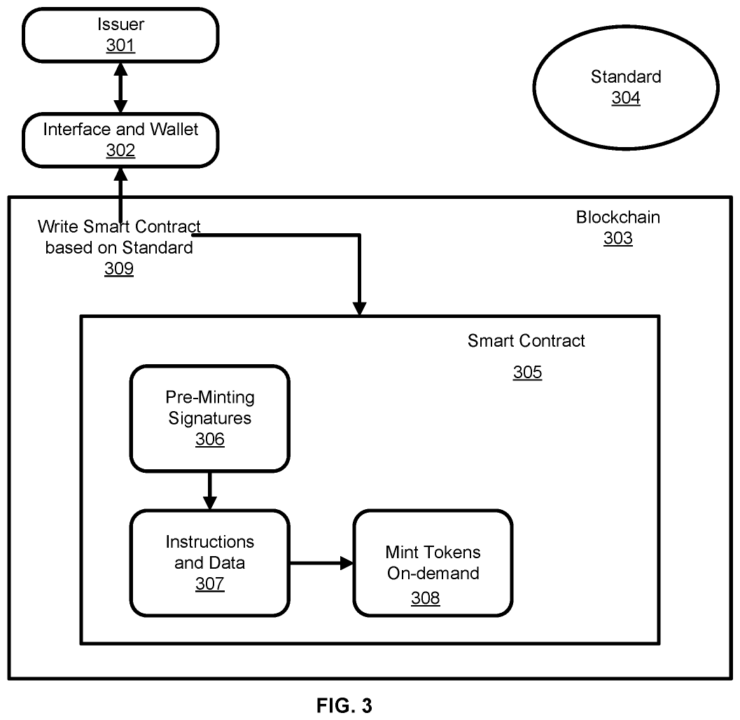

FIG. 3 illustrates the minting of new token 110. The issuer 301 writes a smart contract 305 which is written based on a standard 309, which most exemplary is filling in data and instructions in a form that produces a standard based smart contract 305. The example standard based smart contract 305 can be based on a smart contract standard accepted by the blockchain network 100 or it will be rejected and no address or execution of the smart contract code will be triggered or stored. The issuer 301 can also use the interface 302 and its wallet 302′ private key to submit a standard based smart contract 305 for deployment. In this example standard based smart contract 305 which follows the rules and requirements in the standard 304.

In continuation of the example in FIG. 3 the smart contract 305 once deployed on the blockchain 303 it receives an account address and triggers the initial signature validations functions and completes it the with the required acceptance of validators as shown in an example in FIG. 2, then the issuer 301 can mint the approved token 110 up to the agreed limit. The issuer 301 can also send a message 109 or messages 109 at different times through its account to mint token on-demand 308 at different instances and different amounts per instance up to the guarantor minting limit or the minting limit. A smart contract 305 is configurable to generate, mint and control the issuance of one or more tokens 110. The generation of tokens 110 is performable in a single block in on the blockchain network 100 with the desired number of tokens 110 and at any time the user wishes to issue token 110.

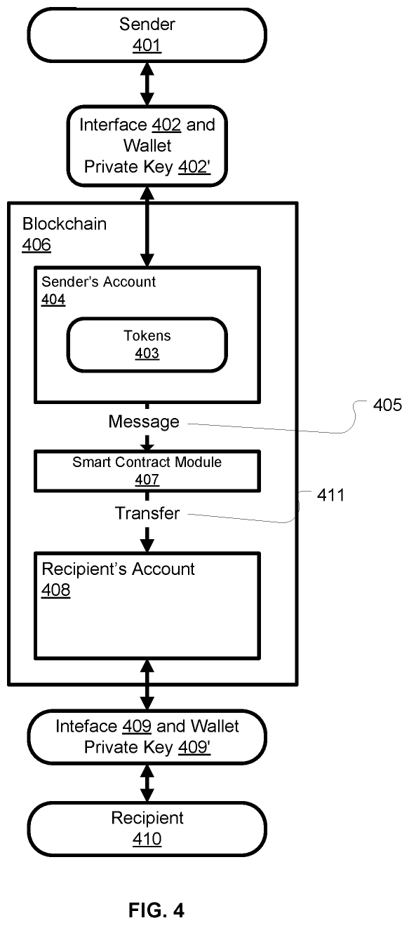

Turning now to FIG. 4, a process for a sender 401 to transfer 411 one or more tokens 403 to a recipient 410. Sender 401 uses interface 402 and wallet 402′ to access the sender's account 404. The sender 401 can see its balance of token 403 and use the interface to send a message 405 to a smart contract module 407 to request a transfer of one or more tokens 403 to the recipient's account 408.

The smart contract module 407 initiates a request for transfer 411 of tokens by messaging the recipient's account 408 to test if there are restrictions set by the recipient in its account for accepting transfers or tokens 403. With no restrictions, the smart contract module 407 completes the transfer and updates through blocks on the blockchain 101 that ledgers on the network to reflect the transfer of tokens 403. The recipient's account 408 is also updated with the tokens 403 received and the recipient 410 can then access recipient's account 408 through an interface 409 and wallet 409′.

Users can trigger an exchange of one or more tokens via a token exchange process as illustrated in FIG. 4. The user can send a message to exchange a smart contract which messages another account or accounts for agreement on the exchange terms between or among them and requires all accounts to agree in order to complete the transfers and create blocks and update the accounts.

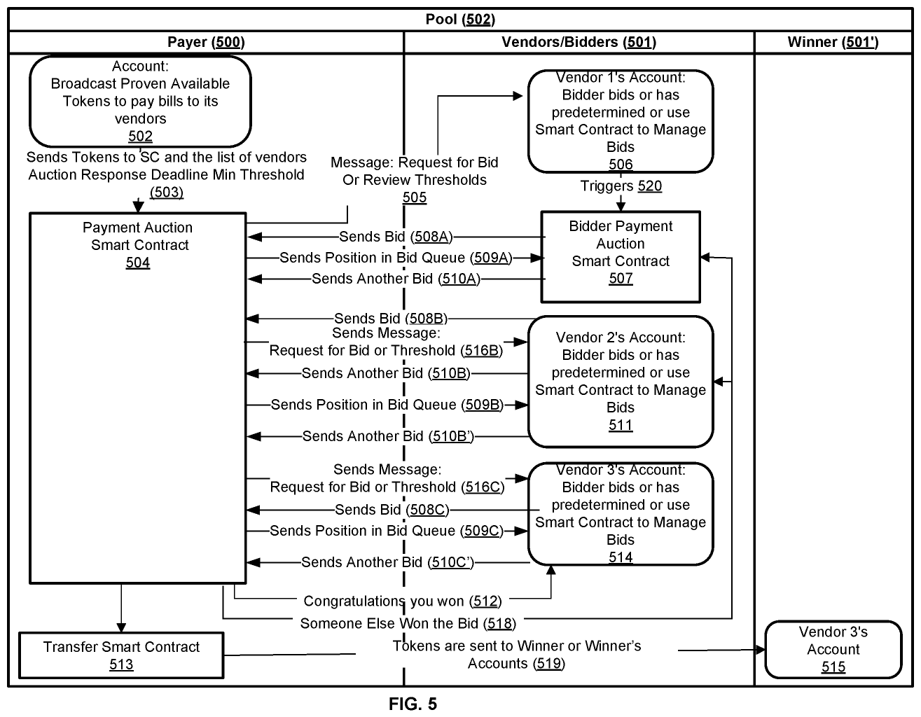

A payment auction agent is configurable to that manage an auction and price discovery between two or more parties (e.g., vendor 1 506, vendor 2 511, and vendor 3 514) to a payment transaction, a token exchange or a token sale as illustrated, for example, in FIG. 5 which illustrates an example of price discovery using a pay auction smart contract module 504 where a payer 500 who had previously purchased goods and services from certain vendors/bidders 501 and has outstanding bills of varying amounts and payment terms to pay these vendors 501. The payer 500 can be part of a pool 550 and use an auction method to maximize the use of its tokens 110 and the value of such tokens 110. Payer 500 can also use its wallet and an interface to send an auction notice message 503 from the user controlled account 502 to the pay auction smart contract 504, with the auction notice message 503 including the amount of token 110 available and dedicated to be paid in this auction, the list of vendor account addresses and amounts owed to each in fiat or other currency, and the minimum threshold of discounts on the billed amount and an a deadline for the auction. The auction notice message 503 triggers a pay auction smart contract module 504, and the pay auction smart contract module 504 executes code that reads the data and instructions in the auction notice message 503 and sends request for bid message 505 to one or more vendors 501 (shown as request for bid message 505 to vendor 1 506). The request message 505 sent to one or more vendors 501 is addressed to the one or more vendor/bidder accounts 506 whether the vendor accounts 506 are controlled by a vendor, e.g. vendors 1-3 506, 511, 514, a bidder auction smart contract 507, or starts with a user controlled account 502 that sends an auction notice message 503 to trigger a bidder auction smart contract 507. The auction smart contract 504 request message 505 contains a request for bid on the available supply of token 110. One or more vendor/bidders 501 reply to the request message 505 where a vendor/bidder 511, 514 send a bid message 508B or a vendor/bidder's auction smart contract 507 sends a bid message 508A, which may include declining to participate or a bill value discount offer.

Upon receiving bid message from a vendor 506A, 506B, 506C from one or more vendors/bidders 501, auction smart contract 504 processes the data and instructions in the one or more bid message 508A, 508B, 508C and sends a queue position message 509A, 509B, 509C to each vendor/bidder 501, which may include information about whether the vendor's offer is not qualified because the discount does not meet a bid threshold of the payer's 500 auction message 503, where the vendor/bidder bid is ranked among the vendors/bidders 501 bids, or a reminder to submit a bid. A reminder to submit a bid or request that the bid meet a threshold 516B, 516C can be sent to any vendor. If the vendor receives a notice that the bid does not meet the threshold, another bid 510B, 510C can be send, at which point a further notification of the queue position 509B, 509C can be sent. In response to the updated queue position notification, another bid can be sent 510B′, 510C′

Vendors/bidders 501 accounts, e.g. vendor/bidder accounts 506, 511, 514, receive the queue position message 509A, 509B, 509C and can reply with a newer bid (e.g., another bid 510A, 510B, 510C) to improve the vendor/bidder's 501 ranking within the bidding pool and chances of winning the auction or confirm the vendor/bidder's 501 bids in a bid confirmation message 510, which can be sent by a vendor account 506, 511, 514 from a user or by a bidder auction smart contract 507, which is intended on making bids automatically within parameters provided by an algorithm or a user or artificial intelligence within it or through a properly connected off-chain source.

The ranking and bids received in an auction are disclosable with or without identification of any or all of the individual vendors/bidders to the payer 500 and the Payer 500 can change discount thresholds or maintain them or keep progressing through the automated auction smart contract 504. The auction smart contract 504 program can execute an automated dynamic threshold, which can use an algorithm such as incrementally reducing discount percentage on bills or the ask price on token 110 until a maximum threshold bid from a vendor is hit and the bid auction process outlined in FIG. 5 can perform the inverse function on behalf of each vendor using the bid auction process to bid on the token 110. After a couple of iterations of bids from vendors/bidders 501, the auction smart contract 504 awards one or more winning vendor/bidders 501 and sends a winning bid message 512 informing the winner 501′ and providing remittance data of the win.

At the conclusion of the auction, a notice can be sent to vendors advising them whether they won 512 or did not win 518.

Payment of the auction smart contract 504 is then triggered through a transfer message a transfer smart contract 513 with appropriate standards is created to transfer one or more tokens 110 based on the winning bid amount to each winning vendor's account 515. The pay-auction module and the bid-auction module are executable programs running on the distributed network nodes, e.g. virtual computing device 106 , to execute the processes illustrated in FIG. 5.

If the winner does not or is unable to complete the smart contract 504, the system can advise the next highest bidder that it has the option of completing the bid.

A payment protocol can also be used as part of the system and methods, where a message 109 containing remittance data include the amount of token 110, issuer of the token 110 and bill or invoice to be paid is sent as a payment offer from a sender's account to a recipient account. Sending the payment offer enables the recipient of the payment offer message or its smart contract account to accept, reject with or without comments on the payment offer by sending a message back to the payment offeror's (i.e., payer's) originating account. If the payee accepts the terms of the payment offer with token 110, then the payment offer smart contract will be triggered and complete the transfer of the tokens from the payer's account to the recipient's account and use blocks to complete it and update the ledgers on the blockchain network 100.

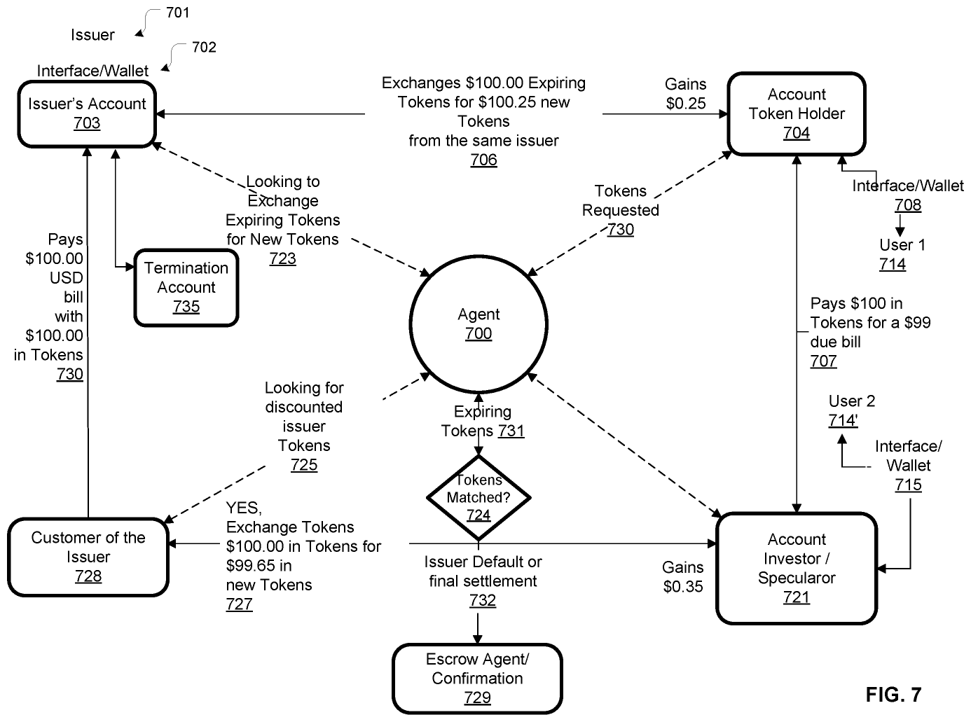

As discussed in more detail with respect to FIG. 7, the user can configure an expiration date for tokens and instruction in the smart contract creating token for those minted token to expire (“expiration date”); e.g. for commercial paper equivalent token the date is likely within 270 days of minting the token. The expiration date for the one or more tokens and instruction in the smart contract can also create a token prior to executing the signature validations function. A TYPE-A standard smart contract can also be used that contains executable code to calculate or observe the passage of time and to expire the token on a future expiration date. When a TYPE-A standard smart contract is used a clearing agent is provided that controls account and is accessible to the entire blockchain. The clearing agent provides a search mechanism to find one or more tokens on the blockchain. Moreover, users can query the account to find expiring tokens or tokens from a particular issuer, etc. The clearing agent can also enable price negotiation on one or more token exchanges between accounts in mass. For example, an account can request a price for expiring token of an issuer, the clearing agent will request prices from all accounts holding the expiring token or send an offer to all these accounts. Pay auction and bid auction can be used in conjunction with the clearing agent search and messaging capabilities. Additionally, the clearing agent is configurable to enable the automatic transfer and exchange of fractional expiring token with new token from the same issuer.

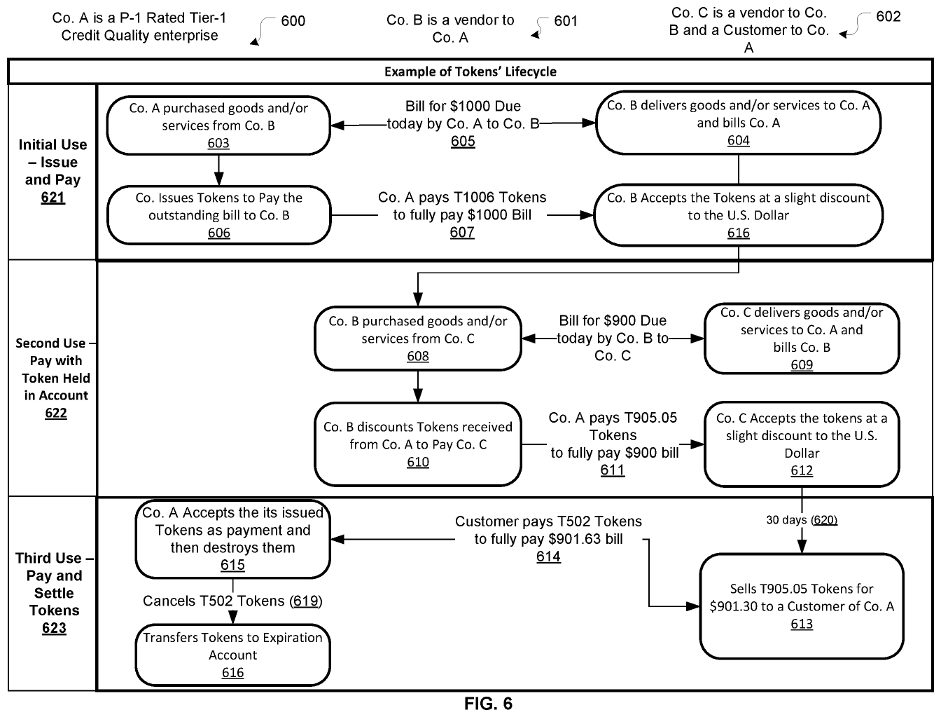

FIG. 6 illustrates an example of a token lifecycle, where a qualified issuer, e.g., Company A (“Co. A”) 600, is a customer of Company B (“Co. B”) 601 and Co. A is looking to issue one or more tokens to fulfill an outstanding obligation, such as a bill payment, to Co. B from step 603. Illustrated are use cases: an initial use—issue and pay process 621, a second use—pay with token held in account process 622, and a third use—pay and settle tokens process 623

Step 603 shows Co. A 600 has purchased goods and/or services from Co. B 601, and Co. B has delivered the goods and/or services to Co. A in step 604, and Co. B billed Co. A for such goods and/or services 605 in this example in the amount of $1,000 in U.S. Dollar due in 60 days from today as shown in step.

Step 606, Co. A issues one or more tokens with an expiration date of 270 days and priced at T1 token=$0.9956 U.S. Dollars based on an implied 0.60% APR equivalent yield on the issued one or more tokens, e.g. accounting for interest and risk premium over risk free rates.

Step 607 shows Co. A paying Co. B T999 in one or more tokens which is equivalent to $994.01 which is lower than the $1000 by ˜$6.00 or 0.600% because of the 60 day early payment to Co. B, whereas Co. B's agreed to the discount given its cost of debt of 5% APR vs. the discount at 2.7% APR. Co. B accepts the T999 token as full payment for the due $1000 invoice and settles the invoice. Company B accepts the tokens 617.

Step 608 shows Co. B has purchased goods and/or services from Co. C 603, and Co. C has delivered the goods and/or services to Co. B 609, and Co. C billed Co. B for such goods and/or services the amount of $900 in U.S. Dollar 618.

On the initial use section 621 in FIG. 6, Co. A and Co. B both benefit from the token and pricing as follows: (1) Co. A benefits from the 2.7% APR yield for 60 days from Co. B's 0.44% discount on the invoice to Co. A and Co. A's 0.60% APR cost of capital, Co. A is able to fund the whole 270 days at zero interest cost (Cost of Capital at 0.60% APR=a 0.44% discount on financing 270 days), not including possible insurance and transaction costs; and (2) Co. B benefits from reducing cost of capital by 46% from 5% APR to 2.7% APR and not incurring debt in the process and Co. B can use the token 110 to pay its own obligations to others.

Step 610 show Co. B wanting to use the one or more tokens issued by Co. A and now held in Co. B's account to pay its obligation on the bill from Co. C's, whereas as shown in step 611, Co. B pays T905.05 token which is equivalent to $901.04 to settle the $900 due bill to facilitate Co. C's ability to use the token and make payments to others.

Step 612, shows Co. C accepting the one or more tokens as a full payment for the outstanding invoice to Co. B and the invoice is then paid and settled.

In the Second Use section 622, Co. B was able to use the one or more tokens to pay its obligations to Co. C without the need for financing. Co. B paid a small premium to Co. C to facilitate the debt free transaction and Co. B's total cost on the token 110 to date is measured by the 60 days of early pay on its receivable of $1000, which is (2.7% APR to Co. A on $1000 and 0.70% APR to Co. C on $900 for a total of 3.33% APR which is 33.4% lower than its 5% APR financing.

As for Co. C, it now holds T905.05 token which it can sell for $901.04. Holding the token will also yield it 0.60% APR which is much higher than checking or savings accounts 105 interest rates of 0.20%. There is strong correlation between all of the rates in FIG. 6 and interest rates on debt and savings accounts, whereas an increase in any of these rates would result in a curved rate increase in all rates and savings percentages in this example and transactions on the network.

Section 3 623 of FIG. 6, shows Co. C holds one or more tokens for 30 days 620 and then selling T905.05 token in step 613, which are now valued at $901.64 to a customer of Co. A for $901.30 and gaining $1.30 in profits. In step 614, the customer of Co. A who purchased the token 110 uses these token 110 to pay $901.64 of an outstanding bill to Co. A and gains of $0.34.

Step 615, Co. A receives one or more tokens in its account from the customer and settles its receivable with the customer, then transfers the one or more tokens to the expiration account where, in step 616, the one or more tokens are destroyed or cancelled 619 and taken out of circulation except for their log, metadata and audit required data. This step completes the closed loop lifecycle of the one or more tokens without requiring any off-chain transactions or fiat currency settlement. The tokens are transferred to an expiration account 616. The closed loop life cycle is a closed loop settlement system.

In FIG. 6, agreements on one or more tokens prices in terms of a U.S. Dollar equivalent among the different parties in the example, is based on an automated auction mechanism provided by the present disclosure whereas thresholds of exchange cost and income on every transaction are established and priced to options the benefits and liquidity of each party and the network. The system can be configured to batch exchange expiring electronic tokens.

FIG. 7 illustrates an example use of an aspect of the present disclosure and an example of the functionality of the clearing agent in the present disclosure. In the FIG. 7 example, a clearing agent 700, is a smart contract controlled account that facilitates finding and requesting asks and bids on tokens. The clearing agent 700 can read the blockchain transaction ledger and track the location of one or more tokens by, for example, amount, issuer and expiration date.

In continuation of the example in FIG. 7, receives and replies to messages on pricing and market available of tokens as defined in messages from users, examples of which are shown in steps 723 and 725. The clearing agent can also be configured to automatically look for matches between accounts that maximize the economic value and fungibility of tokens, for example, linking an account holding token 704 that holds tokens that match the needs of an investor in another creditor account 721 or at another time, the investor's creditor account 721 with the account of customer 728 of the issuer of such token, whereas the clearing agent discovers such links through tracking of token attributes, differences between token attributes, account attributes and the messages received from and exchanged between users and smart contract accounts.

The clearing agent is also configurable to automatically invokes functionality from the pay auction smart contract and the bid auction smart contracts of various accounts to discover market prices and match transactions among accounts. In some configurations, the clearing agent is configurable to automatically calculate and provide quotes to competing accounts until a predetermined limit is hit. Additionally, users can set an auto-exchange feature when the limit is hit. Once the accounts are matched and a transfer price is agreed, or exchange tokens is agreed, the smart contracts that control the transfer of tokens manages the transfers among accounts as explained in the token transfer and token exchange system and methods. Examples of matched transactions are shown in FIG. 7 where the transaction is a token exchange in step 706 where an issuer of token exchanges, for example, $100.00 of expiring tokens for $100.25 in new tokens with the holder of the expiring tokens. In another exchange 727 example, the match is between an investor's account 721 holding tokens and the account 728 belonging to a customer of the issuer of the token's held in the investor's account 721, in which the investor exchanges tokens held in creditor account 721 in return for new tokens of equivalent value issued by a different issuer, whereas the exchange 727 consisted of, for example, $100.00 in expiring tokens to the issuer's customer 728 for $99.65 in new tokens to the investor's creditor account 721.

Another example of matched transactions shown in FIG. 7 occurs when the transaction is a payment of an obligation, a token transfer, from one account to another as show in the transaction between an account holding token 704 and a creditor account 721, where the holder account pays, for example, $100 in tokens to pay and settle an outstanding bill for a $99 to the creditor account 721. In another example, the customer 728 of an issuer 701 can pay a bill due to that issuer 701 with one or more tokens issued by that issuer 701 and held by the customer in the customer's account 728, and as shown in step 730, the customer pays from the creditor account 721 to the issuer's account 703 $100.00 in tokens to settle a due bill in the amount $100.00 US Dollars 730.

By example, user 1 714 can interface via an interface/wallet 708 with account token holder 704, and user 2 714; can interface via an interface/wallet 715 with account inventor/speculator 721.

The issuer can also transfer any of its own issued tokens held in its account 703 to the expiration account 735 to terminate the use and circulation of these tokens on the network. Usually, this step is taken on one or more tokens close to their expiration date or the issuer is reducing debt or taking advantage of interest rate changes or insuring on-chain settlement of their tokens.

The clearing agent can also perform checks 724 on matching expiring tokens 731 prior to the token expiration date, including fractions of a token held in different accounts across the blockchain network, and in the event that no matches are found, including the acceptance of a token holder to receive new issued replacement token from the same issuer or other token from other issuers. The clearing agent may also trigger the escrow confirmation 729 process for an off-chain settlement, such as a final settlement 732, of one or more tokens. An issuer can mint one or more new tokens and exchange such newly minted tokens with one or more of any expiring or expired tokens held in at least one third-party account and with the approval of such party. An issuer can also mint one or more new tokens to transfer to a third-party willing to accept the one or more new tokens in exchange for one or more other tokens to use for the exchange of expiring or expired tokens held in at least another third-party account and with that party's approval. In some configurations, the issuer can mint one or more new tokens to transfer to, for example, a Tier-1 lender willing to mint or provide one or more of its token to replace one or more expiring or expired tokens with holders of the one or more expiring or expired tokens if such holders agree to such exchange. A guarantor guaranteeing the settlement of one or more tokens through replacement, can issue and mint one or more tokens to exchange such new minted token with the one or more expiring or expired tokens with any holder of the expiring or expired token if such holder agrees to the exchange. Additionally, the guarantor guaranteeing the settlement of one or more tokens through replacement, can issue and mint one or more tokens to transfer to a Tier-1 lender willing to mint or provide its one or more tokens to replace expiring or expired one or more tokens with holders of the expiring or expired one or more tokens if such holders agree to such exchange.

An expiration account can be provided that is configurable to receive one or more tokens, turn its one or more tokens balance to zero, and hold only metadata on the number and history and audit compliant information on the received one or more tokens. Issuers can also seek to accept one or more expiring tokens as payment on receivables from customers or others individuals and legal entities that owe them money; or exchange with the accounts holding one or more expiring tokens for newly issued one or more tokens and when they receive their own expiring one or more tokens, they can transfer them to the Expiration account. Escrow agents can also trigger or oversee the transfer of expiring or expired one or more tokens to an expiration account.

In an aspect of the present disclosure the off-chain settlement process is managing through an escrow confirmation process can be included the Escrow confirmation comprises of steps confirming the compliance and performance of duties, by an issuer, the guarantors smart contracts of the related one or more tokens, where the compliance and duties are predefined prior to issuing the initial one or more tokens. Similar to futures contracts on commodities that absolute vast majority of contracts settle in cash without delivery of physical commodities, there is a mechanism for the one or more tokens to be settled in fiat currency rather than a one or more tokens exchange or an accounting payment credit for a debit payment. An escrow confirmation can be performed by at least one escrow agent monitoring events based on the contractual obligations and the instructions in the smart contract which are defined at the time of creating or signing the smart contract signature validations and prior to minting one or more tokens. In some configurations, the escrow confirmation may include off-chain confirmation steps associated with the fulfillment of payments and obligation by maybe a token owner and/or escrow agent, who confirm the remittance or receipt or settlement of payment in an off-chain account or accounts and triggers a token settlement function, to settle one or more tokens, in the relevant smart contract by sending a message to the smart contract from the escrow agent account. Upon the smart contract receiving the token settlement message, the smart contract transfers one or more tokens to an expiration account and deducts the expired one or more tokens from the total token balance in circulation on the blockchain to provide a token settlement.

Where a standard requires at least two escrow agents, the escrow agent can be a smart contract that can perform the escrow confirmation tasks autonomously by electronically observing events on the blockchain network and/or through a data feed from trusted off-chain sources. The clearing agent or escrow agent can be smart contract autonomously running code that may use connectivity through the internet or other networks to bank or depository accounts to automatically verify the transfer of cash or other assets in order to release Tokens in a transfer from the sender to the recipient, such as using PLAID integration to check a bank account for a deposit as a payment for a purchase or settlement of one or more Tokens. Escrow confirmation can also be performed by a user or a smart contract; in either scenario the escrow confirmation is associated with at least one individual or legal entity with legally enforceable commitments and obligations to perform its escrow agent duties.

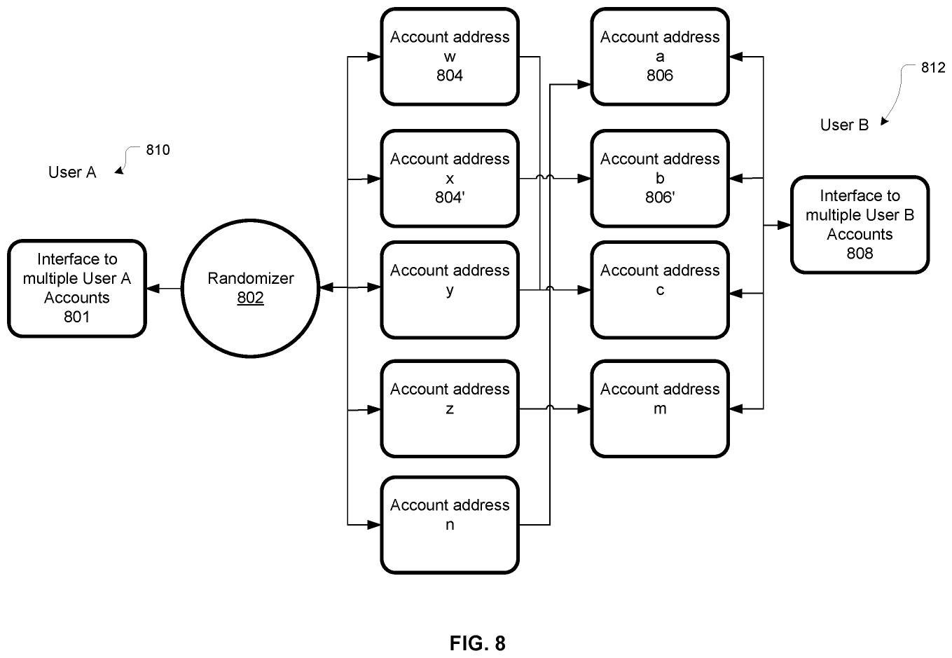

FIG. 8 illustrates an example of a radomizer module. As shown in FIG. 8, a user can also have multiple accounts and can provide one or more of the multiple accounts to another user in the blockchain network in order to exchange and transfer tokens, including making payments with tokens. The executable code on at least one computing processor, is further configurable to randomly (or through a Poison or other distribution) transfer one or more tokens from a plurality of a sender's accounts in varying amounts to a plurality of recipient's accounts. This sending-receiving process can be achieved via a randomizer module, or randomization process. The randomizer is an executable code module of a smart contract running on the blockchain network. A user can use an interface to trigger a message with instructions on token to be transferred through the randomizer module. Moreover, the randomizer module can function by transferring token at variable amounts, rates and frequency to move all the token that a sender wishes to be sent to a recipient. The randomizer module 802 can manage or trigger the transfer of token from one or plurality of the sender's accounts to one or a plurality of the recipient's accounts. Thus, for example, User A 810 triggers the transfer of tokens in step 801 in an amount of an m number of tokens to transfer to User B 812. User A triggers the randomizer module 802, to send the m number of tokens to User B. User B can provide User A with identification information for one or more accounts 806 belonging to User B to receive payments from User A. The randomizer module 802 can then execute code that transfers 803 different amounts of m tokens to be minted by one or more smart contracts, or transferred from one or more master User A accounts (w, x, y, z, n) 804, 804′, in varying amounts that total of m number of token to User B accounts (a, b, c, m) 806, 806′.

As will be appreciated by those skilled in the art User A's accounts 804 with varying amounts of tokens are triggered by the randomizer module to transfer 805 all or a portion of the account balance to one or more of User B's accounts 806 that were randomly, or through an algorithmic distributions process, assigned to receive tokens from one or more User A's accounts 804. User B can then use an interface 808 to access User B's one or more accounts 807 and trigger token transfers. The triggering step can be a single request that transfers tokens to the one or more accounts through the interface 808. User A and User B's transactions are less traceable from an identity of account owner standpoint enabling them to increase transaction privacy.

In engaging the systems and methods according to aspects of the disclosed subject matter a user may engage in one or more use sessions. A use session may include a training session for the user.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any device capable of a computing function that includes computing hardware). As will be appreciated by those skilled in the art, computer-readable storage media does not include communication connections, such as modulated data signals. Any of the computer-executable instructions for implementing the disclosed techniques, as well as any data created and used during implementation of the disclosed aspects, can be stored on one or more computer-readable media (e.g., non-transitory computer-readable media, which excludes propagated signals). Additionally, the computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

Only selected aspects of the software-based implementations are described. Other details that are well known in the art are omitted. For example, it should be understood that the disclosed technology is not limited to any specific computer language or program. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based aspects (comprising, for example, computer-executable instructions for causing a computer to perform any of the disclosed methods) can be uploaded, downloaded, or remotely accessed through a suitable communication means. Such suitable communication means include, for example, the internet, the world wide web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed aspects, alone and in various combinations and sub-combinations with one another. The disclosed methods, apparatus, and systems are not limited to any specific aspect or feature or combination thereof, nor do the disclosed aspects require that any one or more specific advantages be present or problems be solved.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

As will be appreciated by those skilled in the art, the systems and methods disclosed are configurable to send a variety of messages when alerts are generated. Messages include, for example, SMS and email.

The present teachings may also extend to one or more of the following numbered clauses:

(1) A computer-based system for issuing and managing electronic currency, comprising of: at least one executable code module executable by at least one computing device processor configured to create and manage electronic currency; a user-interface allowing a user to trigger the executable code to create a block in a blockchain 101 with new electronic currency at the user's will; and the at least one executable code module to manage the transfer of electronic currency of the same or different attributes and issuers from one user to another on the same blockchain network.

(2) The system of paragraph (1), wherein the electronic currency is cryptocurrency.

(3) The system of paragraph (1), wherein the module of executable code facilitates the matching of electronic currency units of different attributes based on their exchange value with a related fiat currency.

(4) The system of paragraph (1), wherein electronic currency units issued by different issuers or attributes comprise an approximately uniform exchange value per unit with at least one unit of a fiat currency.

(5) The system of paragraph (1), wherein electronic currency units issued by different issuers or with different attributes are exchangeable or transferable by at least one of the executable modules on the same blockchain 101 network.

(6) The system of paragraph (1), wherein the computing system network is a blockchain.

(7) The system of paragraph (1), wherein the computing system network is a virtual computing device.

(8) The system of paragraph (1), wherein electronic currency is minted at any time of an issuer's will.

(9) The system of paragraph (1), wherein electronic currency is minted for any number of units or amounts at an issuer's will.

(10) The system of paragraph (1), wherein the electronic currency issued by an issuer can be destroyed at the issuer's will, on demand, if such electronic currency is in the issuer's account.

(11) The system of paragraph (1), wherein the holder of electronic currency in an account the time value of money on such currency.

(12) The system of paragraph (1), wherein the units of electronic currency is priced based on units of a fiat currency.

(13) The system of paragraph (1), wherein the units of electronic currency represent financial obligations of the issuer.

(14) The method of paragraph (13), wherein the financial obligations of the issuer are enforceable in at least one legal jurisdiction.

(15) The method of paragraph (13), wherein the financial obligations are debt obligations.

(16) The method of paragraph (13), wherein the financial obligations are equity or shares of ownership.

(17) The method of paragraph (13), wherein the financial obligations are repurchase agreements.

(18) The system of paragraph (1), wherein an issuer of the electronic currency expires at a set date.

(19) The method of paragraph (18), wherein the issuer of the expiring electronic currency can set a new expiration date in the future.

(20) The method of paragraph (18), wherein an issuer can mint new electronic currency to exchange such new minted token with the same issuer's expiring or expired electronic currency held in at least one third-party account at the approval of that party.

(21) The method of paragraph (18), wherein an issuer can mint new electronic currency to transfer to a third-party willing to accept these token in exchange for other electronic currency.

(22) The method of paragraph (18), wherein a party guaranteeing the settlement of electronic currency with an expiration date can issue and mint new electronic currency to exchange such newly minted electronic currency with the expiring or expired electronic currency.

(23) The method of paragraph (22), wherein a holder of units of expiring or expired electronic currency agrees to exchanging any number of these held units for units of another electronic currency.

(24) The system of paragraph (1), wherein an issuer can hold multiple accounts.

(25) The system of paragraph (1), wherein the executable code is assigned a new account when minting new blocks of new units of electronic currency.

(26) The system of paragraph (1), wherein executable code that can be run on at least one computing processor configured to be triggered randomize transactions between one user and another user by randomizing transaction amounts among a plurality of accounts belonging to the same two users.

(27) The system of paragraph (26), wherein the executable code is autonomous in performing its functions.

(28) The system of paragraph (1), wherein executable code that can be run on at least one computing processor configured to be triggered which creates at least one new account for the recipient when a user is sending or transferring electronic currency to such recipient.

(29) The system of paragraph (28), wherein the executable code is autonomous in performing its functions.

(30) A computer-based system for validating data on a distributed ledgers comprising of: at least one executable code module executable by at least one computing device processor and configured to validate data on a computing system network; a user-interface allowing a user to use a private key access to validate data related to electronic currency by cryptographically signing the data.

(31) The system of paragraph (30), wherein a user validates data related to the issuer.

(32) The system of paragraph (30), wherein a user validates data relating to be minted electronic currency.

(33) The system of paragraph (30), wherein a user validates data relating to another user.

(34) The system of paragraph (30), wherein a user can have multiple accounts with multiple addresses.

(35) The system of paragraph (30), wherein the executable code module is configured to manage the exchange electronic currency units between one user and a plurality of users.

(36) The system of paragraph (30), wherein one or more issuers can issue multiple electronic currencies with different attributes circulating on the same blockchain network.

(37) The system of paragraph (30), wherein a self-regulating executable code, executable on at least one computing processor, is configured to batch exchange expiring electronic currency units with newly issued units.

(38) The system of paragraph (37), wherein the executable code is triggered by a user.

(39) The system of paragraph (37), wherein the executable code is triggered automatically by the executable code regulating expiring electronic currency

(40) The system of paragraph (30), wherein the electronic currency units have intrinsic value in fiat currency terms.

(41) The system of paragraph (30), wherein the executable code module runs on the blockchain as a self-regulating digital contract with functions, instructions, and stored data.

(42) The system of paragraph (30), wherein the executable code module runs on a virtual computing device as a self-regulating digital contract with functions, instructions, and stored data.

(43) The system of paragraph (30), wherein at least one executable code module automatically assigns new account addresses to users and other executable code modules on the computing network.

(44) The system of paragraph (30), wherein a unit of counting the electronic currency is accepted as equivalent to an amount of fiat currency disclosed as the obligation of the issuer.

(45) The system of paragraph (30), wherein financial instruments are transformed to electronic currency.

(46) A computer-based system for price discovery on a distributed ledger comprising of: at least one executable code module, executable by at least one computing device processor, and configured to provide price discovery and matching of exchange prices of electronic currency on the same blockchain network and the same user accessible accounts 105; and a user-interface allowing a user to use a private key access to validate data related to electronic currency by cryptographically signing the data.

(47) The system of paragraph (46), wherein the executable code is autonomous in performing its functions of locating and bidding on electronic currency of different attributes.

(48) The system of paragraph (30), wherein the system is a closed loop settlement system.

(49) The system of paragraph (30), wherein the executable code manages a plurality of clients' interactions, the execution and recordation of executed transactions in a private blockchain 101-based settlement network.

(50) A non-transitory, computer-readable medium storing computer-executable instructions for issuing and managing electronic currency.

(51) A computer-based system for randomizing electronic currency transfers between at least two users on a connected network comprising of: at least one executable code module, executable by at least one computing device processor, and configured to provide the splitting of electronic currency units being transferred from at least one user to at least another user, among multiple accounts 105 of each user; and a user-interface allowing a user to use a private key access to enable a user to trigger transfers using the executable code.

(52) The system of paragraph (51), wherein the system and methods of paragraph (51) are used.

(53) The system of paragraph (51), wherein the executable code splits the total of electronic currency being transferred from at least one user to at least another user from at least one account to a plurality of accounts.

(54) The method of paragraph (53), wherein the total of electronic currency is being transferred from one account to at least two accounts.

(55) The method of paragraph (53), wherein the total of electronic currency is being transferred from a plurality of accounts to at least one account.

(56) The method of paragraph (53), wherein the total of electronic currency is being transferred from a plurality of accounts to a plurality of accounts.

(57) The system of paragraph (51), wherein the splitting of electronic currency is executed through a randomizing algorithm.

(58) The system of paragraph (51), wherein the splitting of electronic currency is executed through a statistical distribution model algorithm.

(59) The system of paragraph (51), wherein the splitting of electronic currency is executed through a randomizing and statistical distribution model algorithm.

(60) A computer-based system and method for transforming legally binding financial instruments into cryptocurrency, comprising: a non-transitory computing network with at least one processor executing computing code; at least one programming module executable by at least one processor for creating electronic currency and storing data; at least one user with an interface for triggering the creation and management of self-regulated executable code contracts for the creation and management of electronic currency; at least one account of data storage on at least one computing device to store the electronic currency and related data; at least one method of triggering the transfer of electronic currency from one account to another; at least one programming module executable by at least one processor for locking the electronic currency in an account and disabling its circulation among accounts 105.

(61) The system of paragraph (60), wherein the electronic currency represents an intrinsic value of a legally binding right to a value.

(62) The system of paragraph (60), wherein the electronic currency exchange value is protected by the issuer.

(63) The method of paragraph (60), wherein the electronic currency exchange value is protected by insurance at the time of settlement.

(64) The method of paragraph (60), wherein all obligations of the issuer related to the issuer's electronic currency are settled on the blockchain network.

(65) System or methods using the subject matter and techniques described herein.

While preferred aspects of the present invention have been shown and described herein, it will be obvious to those skilled in the art that such aspects are provided by way of example only. Numerous variations, changes, and substitutions will now occur to those skilled in the art without departing from the invention. It should be understood that various alternatives to the aspects of the invention described herein may be employed in practicing the invention. It is intended that the claims define the scope of the invention and that methods and structures within the scope of these claims and their equivalents be covered thereby.

What is claimed:

1. A computer-based system for issuing and managing two or more electronic tokens in a computing system network wherein each of the two or more electronic tokens have one or more attributes, the computer-based system comprises:
at least one executable code module executable by at least one computing device processor configured to create and manage the two or more electronic tokens wherein each of the two or more electronic tokens have an issuer; and
a user-interface configurable to allow a user to trigger the at least one executable code module to create a block in a blockchain on user demand wherein the block has at least one new electronic token,
wherein the at least one executable code module is configurable to manage a transfer of two or more electronic tokens within a blockchain, further wherein the two or more electronic tokens have at least one of different electronic token attributes and different electronic token issuers.

2. The system of claim 1, wherein the two or more electronic token is at least one of a cryptocurrency, a commercial paper, a bond, a financial obligations of an issuer, a debt obligation of an issuer, an equity obligation of an issuer, a repurchase agreement of an issuer, and shares of ownership of an issuer.

3. The system of claim 1 wherein the electronic token is one or more of an electronic currency minted on demand by a user, an electronic currency minted for any number of currency units or amounts on demand by a user, and an electronic currency destroyed on demand when such electronic currency is in an issuer account.

4. The system of claim 3, wherein a currency unit is priced based on a fiat currency.

5. The system of claim 3, wherein at least one executable code module facilitates matching of currency units with different attributes based on an exchange value for the currency units with a fiat currency.

6. The system of claim 3, wherein currency units issued by different issuers or currency units having different attributes further comprises at least one of an approximately uniform exchange value per unit with at least one unit of a fiat currency, and are exchangeable or transferable by at least one executable code module on a blockchain network.

7. The system of claim 1, wherein the computing system network is at least one of a blockchain, and a virtual machine.

8. The system of claim 1, wherein the electronic token has an expiration date.

9. The system of claim 8, wherein the issuer of an expiring electronic token can set a new expiration date.

10. The system of claim 8, wherein the issuer can mint one or more new electronic tokens and exchange the one or more new electronic tokens with an electronic currency in at least one third-party account with an approval of that party before or after the expiration date.

11. The system of claim 8, wherein the issuer can mint one or more new electronic tokens and transfer to the one or more new electronic tokens to a third-party in exchange for one or more third party electronic tokens.

12. The system of claim 8, wherein an electronic token settlement guaranteeing party can at least one of new electronic currency and mint new electronic currency and exchange the new electronic currency with one or more expiring or expired electronic tokens.

13. The system of claim 1, wherein the at least one executable code module is assigned a new account when minting new blocks of new units of electronic tokens.

14. The system of claim 1, wherein the at least one executable code module can be run on at least one computing processor configured to trigger randomize transactions between a first user and at least one second user by randomizing transaction amounts among a plurality of at least one of first user accounts and second user accounts.

15. The system of claim 1, wherein the at least one executable code module can be run on at least one computing processor configured to create at least one new account for a recipient when the user is sending or transferring electronic tokens to the recipient.

16. The system of claim 1, wherein a financial obligation is transformed into and electronic currency.

17. A computer-based system for validating data on one or more distributed ledgers comprising:
at least one executable code module executable by at least one computing device processor and configured to validate data on a computing system network; and
a user-interface configured to allow a user access to validate data related to electronic tokens by use of a private key to cryptographically sign the electronic token, wherein the user can have one or more accounts with one or more addresses.

18. The system of claim 17, wherein a user at least one of validates data related to an issuer, validates data relating to be minted electronic tokens, and validates data relating to another user.

19. The system of claim 17, wherein the at least one executable code module is configured to manage an exchange electronic tokens between a first user and one or more second users.

20. The system of claim 17, wherein an issuer of one or more electronic tokens can issue multiple electronic tokens with different token attributes for circulation on the same blockchain network.

21. The system of claim 17, further comprising a self-regulating executable code, executable on at least one computing processor, configured to batch exchange expiring electronic tokens with newly issued tokens.

22. The system of claim 17, wherein the executable code module is at least one of triggered by a user, and triggered automatically by the executable code module regulating an expiration of the electronic token.

23. The system of claim 17, wherein the electronic token has a value based on a fiat currency.

24. The system of claim 17, wherein the executable code module is configurable to run on at least one of a blockchain and a virtual machine as a self-regulating digital contract with functions, instructions, and stored data.

25. The system of claim 17, wherein at least one executable code module automatically assigns new account addresses to users and other executable code modules on the computing network.

26. The system of claim 17, wherein a unit of counting the electronic token is accepted as equivalent to an amount of a fiat currency disclosed as an obligation of an issuer.

27. A computer-based system for price discovery on a distributed ledger in a blockchain network with user accessible accounts comprising:
at least one executable code module, executable by at least one computing device processor, and configured to provide price discovery and matching of exchange prices of electronic tokens on the same blockchain network having the same user accessible accounts; and
a user-interface allowing a user to use a private key access to validate data related to electronic tokens by cryptographically signing the data.

28. The system of claim 27, wherein the executable code module is autonomous in performing its functions of locating and bidding on electronic currency of different attributes.

29. The system of claim 27, wherein the system is a closed loop settlement system.

30. The system of claim 27, wherein the executable code module is configurable to manage a plurality of interactions selected from execution of transactions in a private blockchain-based settlement network, and recordation of transactions in the private blockchain-based settlement network.

31. A computer-based system for randomizing electronic currency transfers between at least two users on a connected network comprising:
at least one executable code module, executable by at least one computing device processor, and configured to provide a splitting of electronic currency units being transferred from at least one user to at least another user, among multiple accounts of each user; and
a user-interface allowing a user to use a private key access to enable a user to trigger transfers using the executable code.

32. The system of claim 31, wherein the executable code module is configurable to split a total of electronic tokens being transferred from at least a first user to at least one second user from at least one account on the connected network to a plurality of accounts on the connected network.

33. The system of claim 31, wherein a total electronic tokens is at least one of transferred from a first account to at least one second account, transferred from a two or more first accounts to one second account, transferred from two or more first accounts to two or more second accounts.

34. The system of claim 33, wherein splitting of electronic tokens is executed through at least one of a randomizing algorithm, a statistical distribution model algorithm, and a randomizing and statistical distribution model algorithm.

35. A computer-based system for transforming legally binding financial instruments into cryptocurrency, comprising:
a non-transitory computing network with at least one processor executing computing code;
at least one programming module executable by at least one processor for creating electronic currency and storing data;
at least one user with an interface for triggering a creation and management of self-regulated executable code contracts for the creation and management of electronic currency;
at least one account of data storage on at least one computing device to store the electronic currency and related data;
triggering a transfer of electronic currency from one account to another; and
at least one programming module executable by at least one processor for locking the electronic currency in an account and disabling its circulation among accounts.

36. The system of claim 35, wherein the electronic currency represents an intrinsic value of a legally binding right to a value.

37. The system of claim 35, wherein an electronic currency exchange value is at least one of protected by an issuer, and protected by an insurance at a time of settlement.

38. The system of claim 35, wherein obligations of the issuer related to an issuer's electronic currency are settled on a blockchain network.
